(19) United States
(12) Patent Application Publication
(10) Pub. No.: US 2015/0170035 A1
(43) Pub. Date: Jun. 18, 2015

(54) Real time personalization and categorization of entities

(71) Applicant: GOOGLE INC., Mountain View, CA (US)

(72) Inventors: Sarvjeet Singh, Sunnyvale, CA (US); John Roberts Anderson, San Anselmo, CA (US); Ryan Michael Rifkin, San Francisco, CA (US)

(73) Assignee: GOOGLE INC., Mountain View, CA (US)

(21) Appl. No.: 14/096,815

(22) Filed: Dec. 4, 2013

(51) Int. Cl. G06N 5/02

(52) U.S. Cl. CPC G06N 5/022

(57) ABSTRACT

A user model may be generated using affinity and exposure values for each item a user interacts with in an embedded space. The user model may include exemplars which may refer to representative items in the embedded space. Based on the user model, a recommendation of items may be provided to the user. A truncated form of the user model and/or the recommended items may be sent to the user's mobile device.

### BACKGROUND

Modeling user behavior is of interest in order to provide recommendations of content such as music, movies, games, applications, advertisements, offers, etc. A user may become discouraged if recommendations do not reflect the user's feedback in real-time. Traditional machine learning systems (such as logistic regression or embedding systems) can personalize a user model, but require substantial amounts of data about the user and may not be quick enough to operate in real-time.

### BRIEF SUMMARY

According to an implementation of the disclosed subject matter, one or more exemplars may be obtained. Each exemplar may be a representative point in a vector space. One or more items may be obtained. Each item may include a profile in the vector space. A first user interaction for each of the one or more items for a first user may be determined. A weight for the first user interaction may be determined. A first exposure for the first user for each of the one or more exemplars may be determined. The exposure may indicate a first user's preference for an exemplar. A first affinity for an exemplar by the first user may be determined based on the user interaction and the exposure. A first recommendation may be generated based on the affinity for each of the one or more exemplars. The affinity each of the exemplars may be ranked and at least one of the exemplars may be selected based on the ranking A user model may be generated and sent by a server to a mobile device of the user.

In an implementation, a second user interaction may be determined for each of the one or more items and for two or more second users. A second exposure may be determined for the second two or more users for each of the exemplars. A second affinity for the one or more exemplars by the second two or more users may be determined based on the second user interaction and the second exposure. A second recommendation may be generated based on the second affinity for each of the one or more exemplars.

In an implementation, the first recommendation may be truncated to form a truncated recommendation list. The truncated recommendation list may be provided to a mobile device of the first user. A second recommendation list for the first user may be determined. The second recommendation list may be truncated to form a truncated second recommendation list. The truncated recommendation list may be updated to match the truncated second recommendation list.

In an implementation, a system is provided that includes a database and a processor connected thereto. The database may store at least one of a first user interaction, a first exposure, a first affinity, and a first recommendation. The processor may be configured to obtain one or more exemplars. Each exemplar may be a point in a vector space. The processor may be configured to obtain one or more items. Each item may include a profile in the vector space. It may determine the first user interaction for each of the one or more items for a first user. The processor may determine the first exposure for the first user for each of the one or more exemplars. The exposure may indicate a first user's preference for an exemplar. The processor may be configured to determine the first affinity for an exemplar by the first user based on the user interaction and the exposure and generate the first recommendation based on the affinity for each of the one or more exemplars.

An advantage of an implementation as disclosed herein is that a system can be constructed using an embedding system that can perform real time personalization by modeling a user affinity to one or more exemplars. A recommendation may be provided in real time or at each interaction in real time. Additional features, advantages, and implementations of the disclosed subject matter may be set forth or apparent from consideration of the following detailed description, drawings, and claims. Moreover, it is to be understood that both the foregoing summary and the following detailed description provide examples of implementations and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows a computer according to an implementation of the disclosed subject matter.

FIG. 2 shows a network configuration according to an implementation of the disclosed subject matter.

FIG. 3 is an example method for obtaining a recommendation list as disclosed herein.

FIG. 4 is an example system for obtaining a recommendation list according to an implementation disclosed herein.

### DETAILED DESCRIPTION

Systems and methods for building a model for a user and/or an item are disclosed herein. An item may refer to anything that can be recommended to a user (examples include music, images, video, advertising, products, events, people, and so on). Both an item and an exemplar may both be users. Users may refer to entities to which a recommendation may be made. Both users and items may be represented in embedded space. An embedded space may be generated using an embedding system such as Web Scale Annotation by Image Embedding (“WSABIE”) or of a type otherwise known as applied to items. An exemplar may be a point in an embedded space and the location of the exemplar within embedded space may change as a user model is refined or updated as described below.

The model can involve listing affinities, as described below, based on their proximity to exemplars. Exemplars may be entities linked in some fashion and may be represented in an embedded space as a point. For example, a first entity may be a comedy club and a second entity may be a comedian. The representation of these two entities may reflect that the comedian is similar to the comedy club in the context of events (e.g., a comedian could be performing at the comedy club). For each exemplar, an affinity and an exposure may be stored, for example, to a database. An embedding space may contain, for example, on the order of millions of items and one hundred or more dimensions. Each of the items may be points represented by a 100 dimensional vector in the vector space. An exemplar may be a point in the embedded space that is selected based on popularity, for example, by performing a clustering on the embedded space. The number of exemplars may be selected as desired, such as one thousand exemplars. For each of the clusters, a point representing the exemplar may be derived from members of the cluster (e.g., a cluster member or an average of the cluster) that is both popular and close to the median of the cluster. A popular exemplar may be selected because it increases the likelihood that a user may interact with it. For example, an exemplar may be professional football and the selected point for the cluster representing that exemplar may be a particularly popular professional football team. Generally, the derived point can be an actual data point in the embedded space as opposed to an average for the cluster to enable a seamless transfer of the data from one user model to the next. For example, when a user model is reconstructed using new data (e.g., user interaction with an exemplar that may include an affinity and exposure), a new user model may be generated.

As disclosed herein, a number of exemplars may be determined based on a clustering analysis. For example, each professional football team may be an item and would be clustered together. One of the professional football teams may be selected as an exemplar. Initially, the selected exemplar for a professional football team may be a popular one to ensure that some feedback is obtained from the user. For example, the football team XYZ may be selected as an exemplar. If the user indicates, however, that team ABC is the user's favorite, which may be determined based on the user's browsing history, purchase history, video habits, geographic location, etc., then the exemplar for this particular user may be changed from team XYZ to team ABC when the model for the user is revised. The system can provide recommendations for merchandise, events, advertisements, coupons, etc. based on the one or more exemplars for a user. For example, initially, the system may have provided an offer for tickets to a user for team XYZ. The user may dismiss that offer or down vote it. After determining the user prefers team ABC, a subsequent offer for tickets to watch team ABC may be met with a positive response, thereby strengthening the user's relationship with team ABC (e.g., causing a higher affinity and/or exposure for team ABC for the particular user, as described below).

For each exemplar for each person, two numbers may be stored. One number is an affinity that indicates whether the person had a positive interaction with the exemplar or not. For example, a thumbs-up on a video or purchase for a particular restaurant may be a positive indicator while a click to dismiss an advertisement may be a negative indicator. Each indication may be assigned a value that represents the user's affinity for the item in question (e.g., a video or restaurant). The other number can be exposure which can represent how much is known about the affinity or how confident the system is in the affinity. A zero may be the exposure if the user has not provided any indication for an item. For example, songs can have a substantial amount of exposure or information about how users interact with them. Events may be short-lived. That is, an event may take place on the weekend and be recommended to a user on the preceding Thursday.

Items in the embedded space may, as for users, receive an affinity and/or exposure number as well. For example, the advertisement that was dismissed by a click in the above example may be an item. It may receive a negative indicator for its affinity because it was dismissed and an exposure since it was presented to the user. For every event, a correlation of likes (i.e., affinity) with each one of a number of exemplars, such as a comedy club, may be determined. Other examples of exemplars may be a particular city, particular sports team, a particular show, etc. When describing people or events, a single number may not be sufficient to represent one or the other in embedded space. For example, a user may prefer heavy metal music and enjoy barbeque. However, that does not necessarily mean that heavy metal and barbeque are like one another with respect to their representations in the embedded space. Thus, the user's taste cannot be represented as a single point in the embedded space.

A user model may be seeded based on a search history, browsing history, purchase history, etc. An event may be seeded with a web reference and placed in embedded space. For example, a web reference may contain one or more nouns that described the content on the page. Some of the web reference affinities may be placed into the model and relate to exemplars. Seeding may refer to initial values assigned to an event, a user, and/or an exemplar. For example, a never-before-seen TV show will not have any user interaction initially; however, it may be seeded based on details about the show (e.g., plot, subject matter, actors, director, etc.) so that it may be recommended to an initial set of users. The initial set of users may provide a response to the TV show and affinity and exposure of the TV show may be adjusted in real time. Thus, in real time, as a user may positively react to an event and the event and the user can be made to look more like one another in the embedded space (i.e., the distance between them may decrease). When the user reacts negatively to an event, the user and the event can be made to look further apart. Thus, the disclosed system can combine a crowd-sourced model of events with collaboratively filtering recommendations to users.

An input for every item xᵢ, iε{1, . . . , xᵢ, . . . , x_{N}} and a list of exemplars m₁, . . . , mⱼ, . . . , m_{E} may be obtained. N may refer to the number of items in the data set and E may refer to the number of exemplars. The data may be indexed using i and j for the exemplars. Given a user, u, the weight, w_{u,i}, of the user's interaction with item i may be computed. For example, in a radio model, a weight of 1 may be assigned to each item (e.g., a song) to which the user has listened, an additional weight of 0.5 for a thumbs-up (indicating the user enjoyed the song), a weight of −0.2 if the user skips a song, and an additional weight of −0.5 for a thumbs-down (indicating the user disliked the song). U may be defined as the set of items with which the user has interacted. The user's exposure to an exemplar j may be defined as:

e_{u,j}≡\sqrt{Σ_{iεU}(xᵢ^{T}·xₘ_{ⱼ})²} Equation 1

The exposure, as stated above, may represent how much knowledge is available about a user's preference for an exemplar. It may not take into account the user interaction weights, w_{u,i}. Exposure may be concerned with whether or not the user has interacted with the item at all. It may be possible for an item U to have w_{u,i}=0. This may indicate that the user was exposed to item, i, but the user did not indicate a positive or negative preference for it.

For a user, u, the user's affinity for the jth exemplar may be computed by summing over the user's interactions as shown in Equation 2:

$${a}_{u , j} ≡ {\sum }_{i ∈ U}^{ } \frac{{w}_{u , i} ( {x}_{i}^{t} \cdot {x}_{{m}_{j}} )}{{e}_{u , j}} = \frac{{\sum }_{i ∈ {Uw}_{u , i}}^{ } ( {x}_{i}^{t} \cdot {x}_{{m}_{j}} ) + {p}_{{a}_{j}}}{\sqrt{{\sum }_{i ′ ∈ U}^{ } {( x {′}_{i}^{t} \cdot {x}_{{m}_{j}} )}^{2}} + {p}_{{e}_{j}}^{2}} \qquad Equation 2$$

The affinity, a_{u,j}, has the same “units” as the user interaction weights, w_{u,i}. The p's are prior, initial values before the system has observed any user interactions. In Equation 2, the user has a total weighted interaction of pₐ_{ⱼ} and exposure of pₑ_{ⱼ} with exemplar, j. If the prior counts, pₐ_{ⱼ} and pₑ_{ⱼ}, are set to zero, then before observing any user actions, the exposures will all be zero and the affinities are all undefined (e.g., 0/0). Nothing may be recommended at this point since nothing is known about the user. Instead, if the user model is seeded with a signal positive interaction with item i with weight w_{u,i}, a valid exposure and affinity for each exemplar may be computed. The numerator and the denominator of the affinity equation will cancel to a sign. Thus, the affinity a_{u,j} will be w_{u,i}sgn(xᵢ^{T}·xₘ_{ⱼ}) and this may prevent any meaningful distinction between different exemplars.

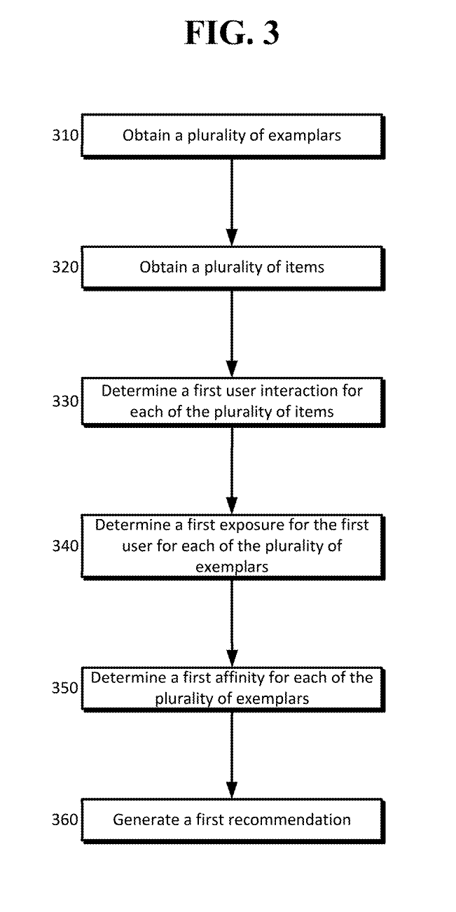

In an implementation, an example of which is provided in FIG. 3, one or more exemplars may be obtained 310. Each exemplar may be a point in a vector space. The vector space may refer to embedded space as described above. The point selected as the exemplar in embedded space may be derived from a clustering (e.g., k means clustering) that has been performed on the embedded space as described earlier. For example, a point may be a set of numbers (e.g., a hundred numbers) representing the embedding space coordinates. An item may be a point in this space as well or it may be represented as having an affinity and/or exposure. One or more items may be obtained at 320. Each item may include a profile in the vector space. The profile may include affinity and exposure values for one or more exemplars. A first user interaction with each of the items for a first user may be determined at 330. A first exposure for the first user for each of the exemplars may be determined at 340 and a first affinity for each of the exemplars by the first user may be determined based on the first user interaction and the first exposure at 350. For example, a user dismissing a recommended event or providing a rating to an Indian restaurant may be weighted and used to determine a user's affinity as described in Equation 2 above. The user's exposure may also be determined for each item (e.g., the event and the restaurant). The event may be an upcoming professional football game between team ABC and team XYZ. The exemplar may be professional football in this example. Another exemplar for the restaurant may be Indian restaurants.

A first recommendation, for the first user for example, may be generated based on the first affinity for each of the exemplars at 360. As a user interacts with exemplars over time, the user's affinities for exemplars may be determined and become increasingly accurate because the user will have more exposure to the exemplars over time. A threshold affinity value may be used to establish a cutoff of the items that the system will not use as a basis for a recommendation. A user model may be generated based on the user's interactions with the exemplars. The user model may be sent out via a server to a user's device such as a smartphone or laptop. The user model may be updated in real time as the user interacts with more exemplars and/or items. In an implementation, a second user interaction may be determined for each of the one or more exemplars for two or more users. A second exposure may be determined for the second two or more users for each of the one or more exemplars as described above for a single user. A second affinity may be determined for each of the one or more exemplars by the second two or more users based on the second user interaction and the second exposure. A second recommendation may be generated based on the second affinity for each of the one or more exemplars. Thus, a user model may be generated for each user in the system and updated in real time.

In some configurations, the affinity for each of the exemplars may be ranked and at least one of the exemplars may be selected based on the ranking. The selected exemplar, for example, may serve as the basis for a recommendation for an event, an item, an advertisement, a coupon, etc. For example, if the highest ranking exemplar for the first user is team ABC, the user may receive an advertisement for some team ABC-inspired paraphernalia or a notice that team ABC is playing team XYZ this weekend and a link for a ticket purchase option. A score for item i may be computed as shown in Equation 3 so that a ranked list of candidate items to recommend to the user may be generated.

s_{u,i}=Σⱼa_{u,j}a_{i,j}\sqrt{e_{u,j}} Equation 3

Candidates may be ranked based on the user model described by the exemplars. A candidate may be any item represented by a point in the embedded space, including exemplars. In some configurations, a candidate may be represented by a model containing exemplars of its own (as compared to being represented by points in embedded space). In such a configuration, candidate models may vary in time based on feedback or user interaction, allowing the candidate models to be “crowd-sourced.” Each of the candidates and/or candidate models may be ranked using Equation 3 and at least one of the candidates may be selected based on a diversity level. Diversity may refer to the chance that a user will like the candidates selected and can be characterized as a probability. Low diversity may indicate that the user will have a high affinity and high exposure. High diversity may indicate that there is low exposure and, thus, the certainty that the user will like the selected candidates will be reduced. The amount of exposure can be used to tune the diversity of events and/or items the system will recommend. Thus, more exposure may be associated with a less diverse set of events and, conversely, less exposure may be associated with a more diverse set of events. Thus, increasing exposure can improve the likelihood that a user will like the candidates selected. A more diverse group of events and/or items may be utilized to experiment to ascertain more information about the user's preferences. For example, some of the recommendations may be tangentially related to items for which the user has a high affinity, but no direct interaction. This encourages user interaction to expand beyond a few selections for which the user has direct interaction. A diversity level may be a threshold probability that a user will like the recommended event and/or item. A diversity level may be set to select at least one of the ranked items based on Equation 3.

Affinities and exposures are both defined in terms of linear sums over interactions and can be computed incrementally. Therefore, in a dense representation such as the embedded space or vector space, the “state” can be updated by an amount of work proportional to the total number of exemplars. In some instances, a sparse representation may be utilized. The sparse representation may have non-zero affinities for a small number of exemplars for the user and each item may only be represented by its largest (e.g., magnitude) affinities to exemplars.

As stated above, a ranked list of items based on the user's affinities and exposures to each item on the list may be determined. The complete embedded space that contains the data representing the exemplars and the items (e.g., the user model) may be large and computationally cumbersome. In an implementation, the first recommendations may be truncated to form a truncated recommendation list. The truncated recommendation list may be provided to a mobile device of the first user. The truncated recommendation list may refer to a reduced user model. For example, if the top thirty items are selected for the truncated recommendation list based on the user's exposure and affinity, the truncated user model may reflect only those thirty items and exemplars may only have exposure and affinity entries for those thirty items. The truncated recommendation list may be further compacted as needed for improved response times for the end user's device.

The truncated model sent to the user's mobile device or recommendation list provides a substantial computational advantage in that the full version and the truncated version of the user model do not need to be aligned in response to a user interaction. If a user dismisses a recommendation provided based on the truncated list, the user's interaction may be sent to a server that can perform the computations necessary to adjust or update the user model in real time. In an implementation, a second recommendation list for the first user may be determined. The second recommendation list may be based on user interactions that were not provided for the first recommendation list. Thus the second recommendation list may be based on new or updated user affinity and exposure values. The second recommendation list may be truncated as described above to form a truncated second recommendation list. For example a new user model may be generated based on the updated exposure and affinity values. The updated list of items for which the user has an affinity and exposure may be ranked and a portion thereof may be selected. The truncated second recommendation list may be utilized to update the truncated recommendation list such that the truncated recommendation list matches the truncated second recommendation list. The truncated second recommendation list may replace the truncated recommendation list in some configurations. Thus, the compact user models may be updated in real time to reflect new information about the user's interaction s with exemplars and/or items.

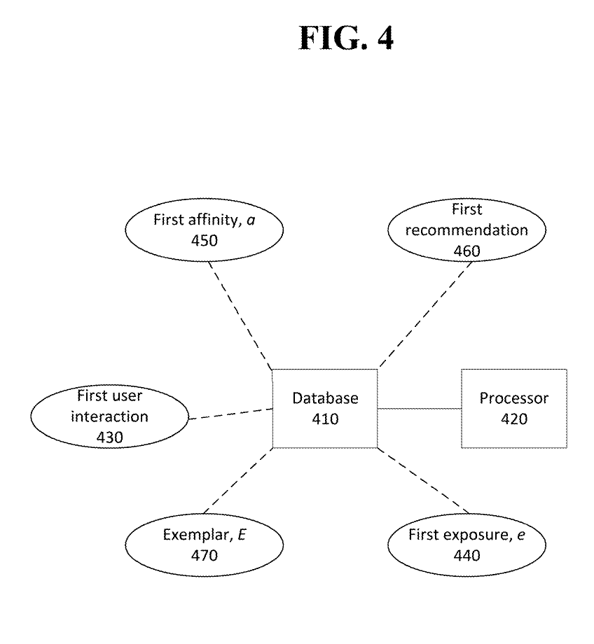

In an implementation, an example of which is provided in FIG. 4, a system is provided that includes a database 410 and a processor 420 connected thereto. The database 410 may store at least one of a first user interaction 430, a first exposure 440, a first affinity 450, and a first recommendation 460. In addition, the database 410 may also store the exemplars 470 as determined by the clustering described earlier. The database 410 may store the user model as well. The processor 420 may be configured to obtain one or more exemplars 470. Each exemplar 470 may be a point in a vector space as described above. The processor 420 may obtain one or more items that have a profile in the vector space. The first user interaction 430 may be determined for each of the one or more items for a first user. The processor 420 may determine the first exposure 440 for the first user for each of the exemplars 470. The exposure 440 may indicate a first user's preference for an exemplar as described above. The processor may be configured to determine the first affinity 450 for each of the exemplars 470 by the first user based on the first user interaction 430 and the first exposure 440 and generate the first recommendation 460 based on the first affinity 450 for each of the exemplars 470.

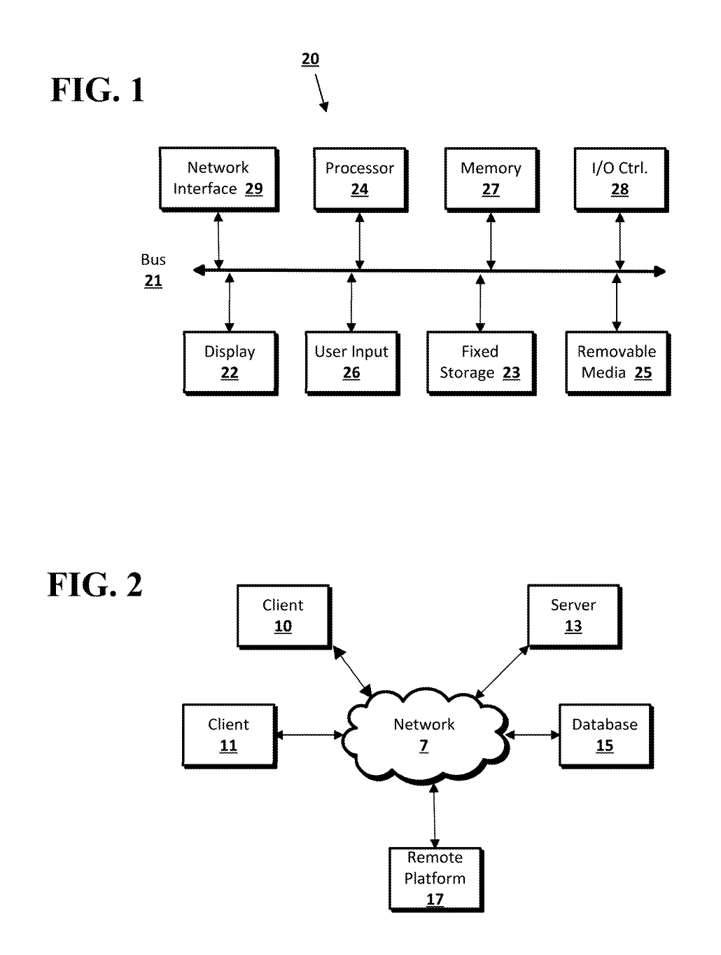

Implementations of the presently disclosed subject matter may be implemented in and used with a variety of component and network architectures. FIG. 1 is an example computer 20 suitable for implementations of the presently disclosed subject matter. The computer 20 includes a bus 21 which interconnects major components of the computer 20, such as a central processor 24, a memory 27 (typically RAM, but which may also include ROM, flash RAM, or the like), an input/output controller 28, a user display 22, such as a display screen via a display adapter, a user input interface 26, which may include one or more controllers and associated user input devices such as a keyboard, mouse, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 2.

Many other devices or components (not shown) may be connected in a similar manner (e.g., document scanners, digital cameras and so on). Conversely, all of the components shown in FIG. 1 need not be present to practice the present disclosure. The components can be interconnected in different ways from that shown. The operation of a computer such as that shown in FIG. 1 is readily known in the art and is not discussed in detail in this application. Code to implement the present disclosure can be stored in computer-readable storage media such as one or more of the memory 27, fixed storage 23, removable media 25, or on a remote storage location.

FIG. 2 shows an example network arrangement according to an implementation of the disclosed subject matter. One or more clients 10, 11, such as local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A method, comprising:
obtaining a plurality of exemplars, wherein each exemplar comprises a point in a vector space;
obtaining a plurality of items, wherein each item comprises a profile in the vector space;
determining a first user interaction for each of the plurality of items for a first user;
determining a first exposure for the first user for each of the plurality of exemplars;
determining a first affinity for each of the plurality of exemplars by the first user based on the first user interaction and the first exposure; and
generating a first recommendation based on the first affinity for each of the plurality of exemplars.

2. The method of claim 1, wherein the exposure indicates a first user's preference for an exemplar.

3. The method of claim 1, further comprising:
generating a user model based on the affinity for each of the plurality of exemplars;
ranking each of the plurality of items based on the user model;
setting a diversity level; and
selecting at least one of the ranked items based on the diversity level.

4. The method of claim 1, further comprising:
generating a user model; and
sending, by a server, the user model to a mobile device of the first user.

5. The method of claim 1, further comprising:
determining a second user interaction for each of the plurality of items for a plurality of second users;
determining a second exposure for the second plurality of users for each of the plurality of exemplars;
determining a second affinity for the plurality of exemplars by the plurality second of users based on the second user interaction and the second exposure; and
generating a second recommendation based on the second affinity for each of the plurality of exemplars.

6. The method of claim 1, further comprising:
determining a weight for the first user interaction; and
modifying the first affinity based on the weight for the first user interaction

7. The method of claim 1, further comprising:
truncating the first recommendation to form a truncated recommendation list; and
providing the truncated recommendation list to a mobile device of the first user.

8. The method of claim 7, further comprising:
determining a second recommendation list for the first user;
truncating the second recommendation list to form a truncated second recommendation list; and
updating the truncated recommendation list to match the truncated second recommendation list.

9. The method of claim 8, wherein the updating is performed in real time.

10. A system, comprising:
a database for storing at least one of a first user interaction, a first exposure, a first affinity, and a first recommendation;
a processor connected to the database, the processor configured to:
obtain a plurality of exemplars, wherein each exemplar comprises a point in a vector space;
obtain a plurality of items, wherein each item comprises a profile in the vector space;
determine the first user interaction for each of the plurality of items for a first user;
determine the first exposure for the first user for each of the plurality of exemplars;
determine the first affinity for each of the plurality of exemplars by the first user based on the first user interaction and the first exposure; and
generate the first recommendation based on the first affinity for each of the plurality of exemplars.

11. The system of claim 10, wherein the exposure indicates a first user's preference for an exemplar.

12. The system of claim 10, the processor further configured to:
generate a user model based on the affinity for each of the plurality of exemplars;
rank for each of the plurality of items based on the user model;
set a diversity level; and
select at least one of the ranked items based on the diversity level.

13. The system of claim 10, the processor further configured to:
generate a user model; and
sending, by a server, the user model to a mobile device of the first user.

14. The system of claim 10, the processor further configured to:
determine a second user interaction for each of the plurality of items for a plurality of second users;
determine a second exposure for the second plurality of users for each of the plurality of exemplars;
determine a second affinity for the plurality of exemplars by the plurality second of users based on the second user interaction and the second exposure; and
generate a second recommendation based on the second affinity for each of the plurality of exemplars.

15. The system of claim 10, the processor further configured to:
determine a weight for the first user interaction; and
modify the first affinity based on the weight for the first user interaction.

16. The system of claim 10, the processor further configured to:
truncate the first recommendation to form a truncated recommendation list; and
provide the truncated recommendation list to a mobile device of the first user.

17. The system of claim 16, the processor further configured to:
determine a second recommendation list for the first user;
truncate the second recommendation list to form a truncated second recommendation list; and
update the truncated recommendation list to match the truncated second recommendation list.

18. The system of claim 17, wherein the update is performed in real time.
